(19) United States
(12) Patent Application Publication
(10) Pub. No.: US 2002/0010588 A1
(43) Pub. Date: Jan. 24, 2002

(54) Human-machine interface system mediating human-computer interaction in communication of information on network

(75) Inventor: Takashi Fujimori, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/904,460

(22) Filed: Jul. 16, 2001

(30) Foreign Application Priority Data
Jul. 14, 2000 (JP) P2000-215062

(51) Int. Cl. G10L 21/00

(52) U.S. Cl. 704/275

(57) ABSTRACT

A human-machine interface system is designed based on the distributed object model and is configured using application nodes, service nodes and composite nodes interconnected with a network. Herein, human-machine interface functions are actualized in forms of distributed objects allocated to the nodes and are realized by mediating interaction between the nodes (or devices). Thus, a human user is able to control an application node to perform a prescribed application by activating a specific service (e.g., speech recognition and speech synthesis) of a service node on the network. Because of the adequate distribution of the objects to the nodes, it is possible to reduce the cost per each device in installation of the human-machine interface system on the network. In addition, operation information regarding the human-machine interface system is commonly shared between the devices, which secures the same feeling of manipulation between the different devices.

### BACKGROUND OF THE INVENTION

1. Field of the Invention

This invention relates to human-machine interface (HMI) systems that mediate communications of information between human users and computer systems on networks by using services such as speech recognition and speech synthesis. This invention also relates to computer-readable media recording programs implementing functions and configurations of the human-machine interface systems.

2. Description of the Related Art

Conventionally, a number of human-machine interface systems are proposed and are actualized centrally using hardware and software resources that are installed in microprocessors, which are built in electronic apparatuses or devices in manufacture. FIG. 13 shows an example of the conventional human-machine interface system that is provided for an electronic device (not shown) to operate in response to human speech (or vocalized sounds) of a human user. Specifically, the human-machine interface (HMI) system is configured by hardware elements such as electronic circuits and components as well as software elements such as programs realizing various functions and processes. That is, the system has various functions that are actualized by function blocks, namely a digitization (or an analog-to-digital conversion) block 1210 for performing analog-to-digital conversion on speech signals, a preprocessing block 1211 for performing preprocessing on ‘digital’ speech signals prior to speech recognition, a pattern matching block 1212 for use in the speech recognition, a series determination block 1213 for use in the speech recognition, a device control block 1215 for controlling operations of the device based on the speech recognition result, a message production block 1216 for providing the human user with information (or messages) based on an internal state of the device, a speech synthesis block 1217 for converting the messages to speech waveforms, and a de-digitization (or a digital-to-analog conversion) block 1218 for converting the speech waveforms to acoustic signals. In addition, a system control block 1214 controls a series of operations of the aforementioned blocks. The pattern matching block 1212 performs a pattern element matching process with reference to a pattern dictionary 1220 for use in the speech recognition, which is stored in a prescribed storage (not shown). In addition, the series determination block 1213 performs a series determination process with reference to a word dictionary 1221 for use in the speech recognition, which is stored in the prescribed storage. Further, the message production block 1216 performs a message production process with reference to a word dictionary 1222 for use in speech synthesis, which is stored in the prescribed storage. Furthermore, the speech synthesis block 1217 performs a speech synthesis process with reference to a pattern dictionary 1223 for use in the speech synthesis, which is stored in the prescribed storage.

The hardware of the system is configured by four elements, namely a device control processor 1201, a signal processor 1202, a combination of a digital-to-analog conversion circuit and an analog sound output circuit 1203, and a combination of an analog sound input circuit and an analog-to-digital conversion circuit 1204. Herein, the analog-to-digital conversion circuit 1204 digitizes analog sound signals (or speech signals). Then, the signal processor 1202 performs preprocessing such as elimination of environmental noise and extraction of characteristic parameters with respect to the ‘digital’ speech signals. In addition, the signal processor 1202 or another processor performs a pattern matching process with reference to preset patterns of characteristic parameters by prescribed units. Further, the signal processor 1202 or another processor performs series determination based on results of the pattern matching process. Based on results of the series determination, the device control processor 1201 controls the device, and it also produces a message for providing information regarding the internal state of the device. Thereafter, the signal processor 1202 or another processor that is provided different from the one for use in the speech recognition process is used to synthesize speech signals based on the message. The digital-to-analog conversion circuit 1203 converts the synthesized speech signals to analog sound waveforms, which are output therefrom. Incidentally, the system also contains other circuit elements that are commonly used for the aforementioned processes, such as memory circuits for accumulation of speech signals, for storing processing results, and for executing control programs. Further, the system contains a power source circuit that is necessary for energizing the circuit elements and a timing creation circuit.

As described above, the conventional human-machine interface system is realized by the aforementioned techniques in processing. However, there are various problems in applying these techniques to a multi-device human-machine interface system configured by multiple devices. A first problem is to increase the cost for actualizing the human-machine interface system by using the conventional techniques in processing. This is because the human-machine interface system that is supposed to be configured by built-in processors has a relatively high ratio between hardware resource and software resource that are used in executing human-machine interface functions. In addition, the system also needs the prescribed resources for handling the devices, each of which has the same functions. In many cases, the human-machine interface functions are not main aims to be achieved by the devices. In other words, the human-machine interface functions are merely provided for improvement of the performance of the devices. Therefore, manufacturers tend to evaluate the human-machine interface functions as having a relatively low value because of the low cost effectiveness.

A second problem is insufficiency of performance and functions that can be installed in the conventional human-machine interface system. Because the actual products of the conventional human-machine interface system have upper limits in the manufacturing cost, it is difficult to provide the human-machine interface system with the sufficiently high performance and functions. Other than the problem of the manufacturing cost, it is possible to list other causes of unwanted limitation to the performance and functions of the human-machine interface system, particularly in the case of small-size devices and portable devices. That is, these devices must have limits in capacities of electric power and heat emission. Because of these causes, it is in fact very difficult to install memories of large capacities in the devices.

A third problem is insufficiency in effective use of information regarding human-machine interfaces between plural devices, which differ from each other. It is believed that the human-machine interface is improved in performability by explicitly and adaptively setting information regarding operation parameters thereof. However, the conventional system is not designed to provide coordination between the devices because each of the devices is designed to independently set the aforementioned information by itself. For this reason, the conventional system requires troublesome setups for the devices at any time.

Next, another example of the conventional human-machine interface system will be described with reference to FIG. 14, which is disclosed in Japanese Unexamined Patent Publication No. Hei 10-207683. This human-machine interface system aims at effective speech recognition for human voices (or vocalized sounds) transmitted thereto via telephone networks and effective response processing. Specifically, this system is configured by a private branch exchange (PBX) 1304, a voice (or speech) response unit 1300, a speech recognition synthesis server 1310, a resource management unit, and a local area network 1308. Herein, the voice response unit 1300 is connected with the private branch exchange 1304 by way of telephone lines 1302, and the private branch exchange 1304 is connected with telephone networks (not shown) via subscriber lines 1306. The human-machine interface system of FIG. 14 is applied to the conventional telephone response procedures, which will be described below.

When the voice response unit 1300 receives an incoming call by way of the exchange 1304, it communicates with the resource management unit 1311 via the local area network 1308 and makes an inquiry about ‘available’ speech recognition devices. The resource management unit 1311 checks whether the available speech recognition device presently exists or not. Then, the resource management unit 1311 notifies the voice response unit 1300 of a result declaring that the speech recognition synthesis server 1310 is presently available as the speech recognition device, for example. The voice response unit 1300 sends speech signals to the speech recognition synthesis server 1310. In this case, the speech recognition synthesis server 1310 performs a speech recognition process on the speech signals, so that its result is sent back to the voice response unit 1300. Thereafter, the voice response unit 1300 communicates with the resource management unit 1311 to make an inquiry about ‘available’ speech synthesis devices. The resource management unit 1311 checks whether the available speech synthesis device presently exists or not. Then, the resource management unit 1311 notifies the voice response unit 1300 of a result declaring that the speech recognition synthesis server 1310 is presently available as the speech synthesis device, for example. The voice response unit 1300 sends a speech synthesis text to the speech recognition synthesis server 1310. The speech recognition synthesis server 1310 performs a speech synthesis process based on the speech synthesis text, so that its result is sent back to the voice response unit 1300. Thus, the voice response unit 1300 sends back a response corresponding to synthesized speech to the exchange 1304 via the telephone lines 1302.

The aforementioned human-machine interface system is configured based on the open system architecture, which causes various problems. A first problem is that it is expensive to run the system having the open system architecture, which is very troublesome in maintenance and management, increasing the running cost. This is because the programming model of this system highly depends upon the communication protocol. In particular, it is difficult to modify configurations of the low-order hierarchy in the network protocol. To raise the extensibility of the system, high costs should be incurred in maintenance and management thereof, particularly under the environment in which the system is configured by nodes of private devices having unspecified functions that allow dynamic reconstruction and coexistence of different kinds of protocols. FIG. 15 shows a configuration of a programming model representative of the system of FIG. 14. In FIG. 15, an application program 1401 operates in the voice response unit 1300, and a server program 1411 operates in the speech recognition synthesis server 1310. In addition, a network transport layer 1405 and a network interface circuit 1406 are provided for the low-order hierarchy of the application program 1401. Similarly, a network transport layer 1415 and a network interface circuit 1416 are provided for the low-order hierarchy of the server program 1411. Further, the application program 1401 uses a special interface specifically suited to the network transport layer 1405, and the server program 1411 uses a special interface specifically suited to the network transport layer 1415. Using these interfaces, data transmission is performed between the application program 1401 and the server program 1411.

A second problem is a difficulty in continuously extending the system for a long period of time because the service process is basically configured based on the command response techniques so that modifications due to extension of the interface of the application program greatly influence a wide range of operations. If the system introduces a new interface structure, it is necessary to update programs with regard to software elements of all of the nodes which are to be influenced by the introduction of the new interface structure. In that case, it is necessary to secure the inoperability with respect to the ‘previous’ interface that was previously used and still has a possibility of operating on the network.

The present invention has the validity that is raised in these days because of the reduction of the networking cost in recent devices and because of the progressing popularization of the networking. For these reasons, there are tendencies in which costs for actualization of interface functions in networks are progressively reduced, and bandwidths provided for networks are progressively broadened. In addition, there is a tendency in which devices having network functions and devices requiring network connections are progressively increased.

Now, the aforementioned conventional devices and their problems will be summarized below.

Basically, the configurations of the conventional devices are classified into two types as follows:

(i) Stand-alone type that has a human-machine interface function therein without using networks.

(ii) Network type that has interconnections with networks, wherein a human-machine interface function is specified therein, but common functions are closed within the use-specified system.

In the case of the stand-alone type, the human-machine interface of the conventional device is perfectly embedded in its operated device. Therefore, the interaction with other devices and systems is not considered for the stand-alone type. In contrast to the stand-alone type, the network type shares a specific human-machine interface function using networks. This type is configured in such a manner that a speech recognition function is provided by an application server. In addition, functions are subjected to decentralization by units of application services, while processing functions are not commonly shared between different media. Therefore, devices of this type can independently deal with the relatively low order of processing, however, this type is inappropriate for unification of human-machine interfaces.

As described above, the following disadvantages are caused because each of the devices independently has its own human-machine interface.

(1) High cost.

(2) Shortage of functions, and hard to use.

(3) Incapability of sharing common information between the devices.

(4) Small adaptability.

(5) Narrow range of usage.

It is possible to list the following reasons that cause the aforementioned disadvantages.

(1) Plural devices independently have the similar functions.

(2) Resources that can be installed in the devices are severely restricted in price and space of installation.

(3) Each device does not have a layer for sharing the common information with other ones because it is designed to be completely independent.

(4) Restriction of resources, and undefined interconnections with networks.

(5) Each device is incapable of sharing the common information with other ones because it is designed to suit a specific use.

### SUMMARY OF THE INVENTION

It is an object of the present invention to provide a human-machine interface system that is improved in function and performance, particularly in relation with services such as speech recognition and speech synthesis.

Concretely speaking, the present invention is improved in such a way that an amount of running cost or manufacturing cost is reduced per each device while functions and performance are improved by installation of human-machine interfaces in devices. In addition, the same feeling of manipulation is guaranteed between the different devices that share the common information with respect to the operation of the human-machine interface. Further, the present invention provides a flexible manner of extension for systems regarding human-machine interfaces. Furthermore, different types of media realizing human-machine interfaces can share the common processing with respect to the high-level information.

The present invention provides a human-machine interface system that is designed based on the distributed object model and is configured using application nodes, service nodes, and composite nodes interconnected with a network. Herein, human-machine interface functions are actualized in forms of distributed objects allocated to the nodes and are realized by mediating interaction between the nodes (or devices). Thus, a human user is able to control an application node to perform a prescribed application by activating a specific service (e.g., speech recognition and speech synthesis) of a service node on the network. Because of the adequate distribution of the objects to the nodes, it is possible to reduce the cost per each device in installation of the human-machine interface system on the network. In addition, operation information regarding the human-machine interface system is commonly shared between the devices, which secures the same feeling of manipulation between the different devices.

More specifically, there are provided low-order service nodes that perform data processing depending upon expression media such as sound and picture, and highorder service nodes that perform data processing independently of the expression media. In addition, each of the nodes has a hierarchical layered structure in execution of software, which is configured by arranging from a top to a bottom, an application object or a service object, a proxy, an object transport structure, a remote class reference structure, a network transport layer, and a network interface circuit.

The technical features of the present invention can be summarized as follows:

(1) Human-machine interface functions are distributed to nodes on the network, wherein common information is adequately shared between the nodes.

(2) The human-machine interface system actualized using nodes on the network is designed based on the distributed object model.

(3) Backend services for human-machine interfaces are realized by hierarchically distributed objects. In addition, high-order hierarchical processing for human-machine interfaces are unified between different expression media, and common information is shared between different media on the network.

(4) Thus, it is possible to remarkably reduce the total cost for actualization of the human-machine interface system using the nodes (or devices) on the network.

(5) As compared with the conventional technology in which human-machine interface functions are not distributed but are completely installed in each of the devices, it is possible to noticeably reduce the cost of hardware and software elements as well as electrical energy consumption, and it is also possible to noticeably ease restrictions in spaces for installation of parts and components in the devices.

(6) The above brings improvements in performance and functions of the human-machine interface system on the network. In addition, it is possible to easily extend the system at the low cost, and it is possible to easily maintain the open architecture system for a long time.

### BRIEF DESCRIPTION OF THE DRAWINGS

These and other objects, aspects and embodiments of the present invention will be described in more detail with reference to the following drawing figures, of which:

FIG. 1 is a system diagram showing interconnections between devices on a local area network for use in actualization of a human-machine interface system in accordance with a first embodiment of the invention;

FIG. 2 is a block diagram showing an example of an internal configuration of an application node shown in FIG. 1;

FIG. 3 is a block diagram showing an example of an internal configuration of a service node shown in FIG. 1;

FIG. 4 shows a software execution structure based on a distributed object model for use in actualization of the human-machine interface system shown in FIG. 1;

FIG. 5 is a flowchart showing a service registration process with respect to a service object;

FIG. 6 is a flowchart showing a service reference process with respect to an application object;

FIG. 7A is a flowchart showing a speech production process that is performed by an application side;

FIG. 7B is a flowchart showing a speech production service process and a speech production service thread that are performed by a service side;

FIG. 8A is a flowchart showing a speech recognition process that is performed by an application side;

FIG. 8B is a flowchart showing a speech recognition service process and a speech recognition service thread that are performed by a service side;

FIG. 9 is a system diagram showing interconnections between devices on a local area network for use in actualization of a human-machine interface system in accordance with a second embodiment of the invention;

FIG. 10A is a flowchart showing a part of a speech recognition process that is performed by an application side;

FIG. 10B is a flowchart showing a speech recognition service process that is performed by a service side 1;

FIG. 10C is a flowchart showing a sentence level scoring service process that is performed by a service side 2;

FIG. 11A is a flowchart showing a following part of the speech recognition process shown in FIG. 10A;

FIG. 11B is a flowchart showing a speech recognition service thread that is accompanied with the speech recognition service process shown in FIG. 10B;

FIG. 11C is a flowchart showing a sentence level scoring service thread that is accompanied with the sentence level scoring service process shown in FIG. 10C;

FIG. 12 is a system diagram showing interconnections between hosts on a local area network for use in actualization of a human-machine interface system in accordance with a third embodiment of the invention;

FIG. 13 is a block diagram showing an example of a configuration of a human-machine interface system which is conventionally known;

FIG. 14 is simplified block diagram showing another example of a configuration of a human-machine interface system which is conventionally known; and

FIG. 15 is a simplified block diagram showing a configuration of a programming model representative of the human-machine interface system shown in FIG. 14.

### DESCRIPTION OF THE PREFERRED EMBODIMENTS

This invention will be described in further detail by way of examples with reference to the accompanying drawings.

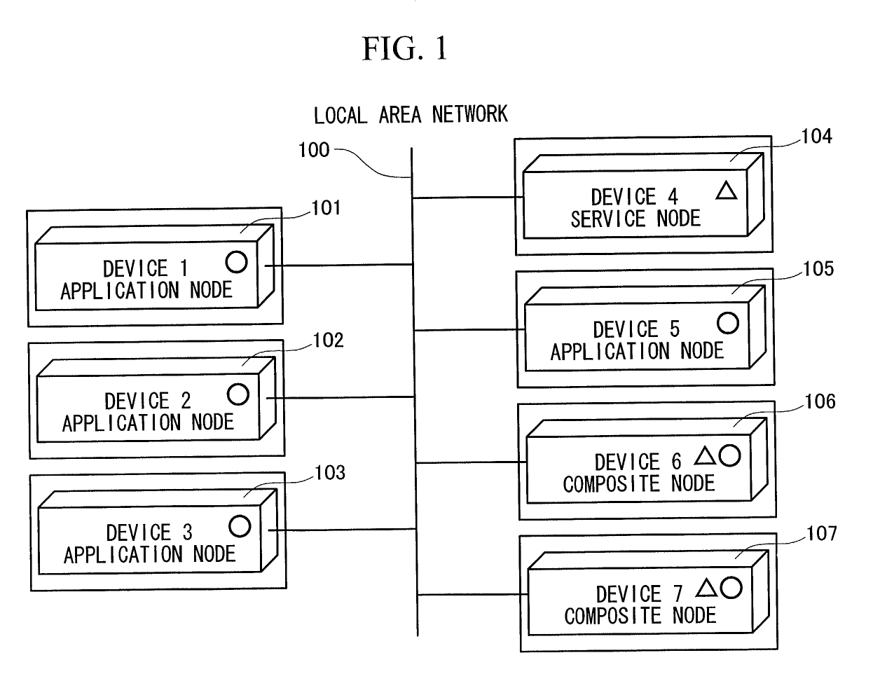

The present invention provides a human-machine interface function among small-scale devices that are connected to a network by wire communication or wireless communication. It realizes high performance and flexible extensibility in the human-machine interface system at low cost. Herein, the term ‘human-machine interface’ is used to designate a device that meditates human-machine interaction or human-computer interaction, as well as the software for controlling the device. FIG. 1 shows a local area network that provides interconnections among devices, which should have human-machine interfaces for entering human operations and for monitoring operated states. That is, these devices contain human-machine interface functions, each of which requires a great amount of complicated calculation for actualizing the human-machine interface for the local area network. In addition, there is provided a device that performs direct operations with respect to the human-machine interfaces, while there are provided a certain number of devices, to which objects are distributed respectively and each of which contains a processing element with respect to each of hierarchical layers for the human-machine interfaces. In short, the human-machine interface system of the present invention is configured based on the distributed object model in which the aforementioned device operates in cooperation with the distributed objects. Thus, it is possible to actualize a hierarchical structure of human-machine interface processing by distributing and commonly sharing functions on the network. Due to actualization of the human-machine interface processing based on the distributed object model, it is possible to efficiently use the hardware resources and information resources among the devices. This brings reduction of cost and improvement of performance in actualization of the human-machine interfaces with respect to the devices. In addition, this enables collective management of information among the devices. For the aforementioned reasons, it is possible to improve maintenance and provide flexible extensibility in the human-machine interface system.

Generally speaking, the distributed object model is considered for the system in which software elements, which are designed and installed based on the object-oriented programming model, are distributed to processing devices (or hosts) which are interconnected together by a network (or communication structure). That is, the distributed object model designates the framework of software in which an expected application is to be actualized by the software elements that mutually call or refer to each other through formatted cooperation procedures. Some of the computer and software companies propose examples distributed object models for practical use. For example, the OMG (i.e., Object Management Group) proposes ‘CORBA’ (namely, ‘Common Object Request Broker Architecture’), the SUN Microsystems proposes ‘Java/RMI (and jini)’, and the Microsoft proposes ‘DCOM’ (namely, ‘Distributed Common Object Model’).

### First Embodiment

FIG. 1 shows a human-machine interface system in accordance with a first embodiment of the invention that is applied to a local area network (or simply referred to as a ‘local network’) 100 which provides communication paths among devices by using physical layers via wire communication or wireless communication. The local area network 100 interconnects together seven devices (or nodes) 101 to 107 in FIG. 1. That is, devices 101, 102, 103 and 105 correspond to application nodes, each of which has its own operation unit for carrying out its original operation and a human-machine interface unit for supplying instructions to the operation unit and for monitoring or acknowledging the state of the operation unit. A device 104 corresponds to a service node for providing the ‘complicated’ function that needs hardware resources and great amounts of calculations and information resources in processing within human-machine interface functions. In addition, devices 106 and 107 correspond to composite nodes that acts as application nodes and service nodes as well. In the above, the term ‘node’ designates the computer, terminal device or communication control device that configures the network as well as its control program.

In the present embodiment, the application node is one of constituent elements of the network that provides input/output functions of data to the terminal device such as the computer, information device and communication control device by using mechanical operations or by using expression media (or representation media) such as vocalized sounds, pictures and images whose contents are directly presented for human users. The service node is one of constituent elements of the network that provides the application nodes with various kinds of information processing functions. The human-machine interface system of the present embodiment is designed to perform data processing between the application node and service node on the basis of the distributed object model. Herein, the application node corresponds to an application object, while the service node corresponds to a service object. To ensure accessibility between the application node and service node, the local area network 100 is connected with a server device (not shown) that provides a distributed application directory service and a distributed object directory service. Examples of techniques regarding the aforementioned distributed object model are disclosed by Japanese Unexamined Patent Publication No. Hei 10-254701 and Japanese Unexamined Patent Publication No. Hei 11-96054.

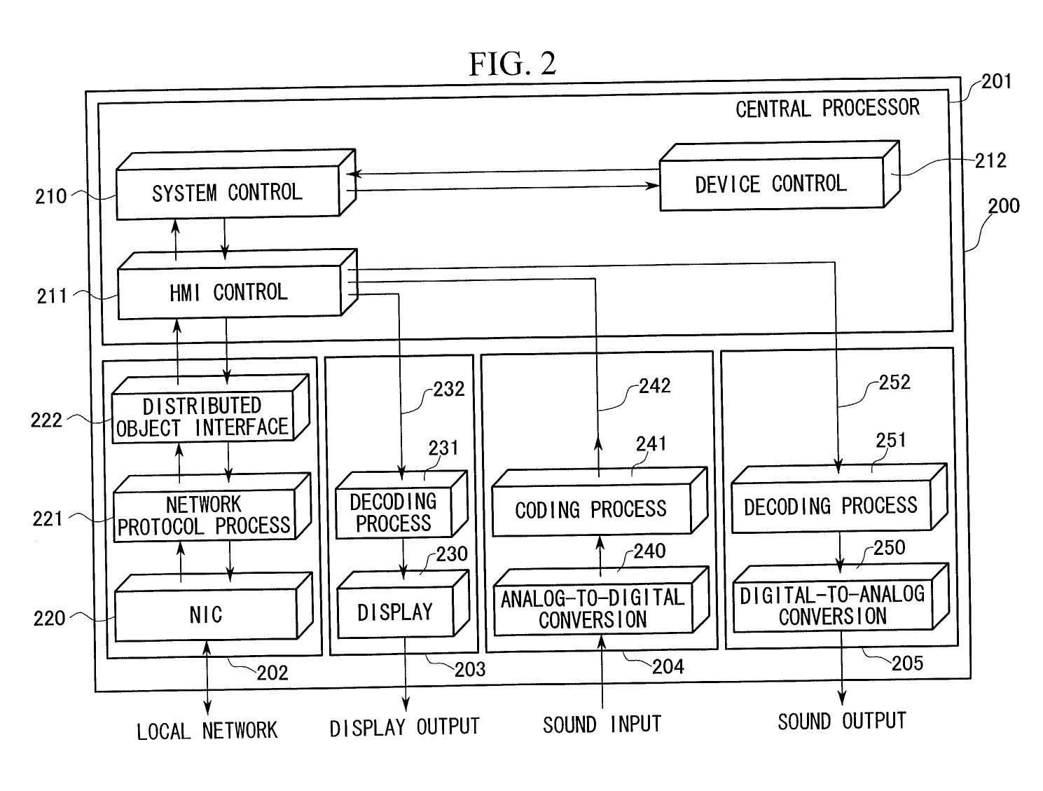

FIG. 2 shows an internal configuration of an application node 200, which corresponds to the application nodes 101, 102, 103 and 105 shown in FIG. 1. Internal functions of the application node 200 are integrated together and are actualized using a central processing unit (CPU), a digital signal processor (DSP) and a storage device as well as the hardware such as an interface and its software program. Basically, the application node 200 is divided into five sections, namely an integrated control section (or a central processor) 201, a local network interface section 202, a display processing section 203, a sound signal input processing section 204, and a sound signal output processing section 205. All of these sections 201-205 are not necessarily installed in the application node 200. That is, it is possible to install one or two of them in the application node 200, or it is possible to provide multiple series of the same section in the application node 200. Outline operations of these sections will be described below.

A system control block 210 plays a central role in the integrated control section 201. That is, the system control block 210 performs macro controls (i.e., operations for executing multiple control procedures collectively) on a device control block 212 with respect to the objected operation of the device. In addition, it issues macroinstructions and performs monitoring with respect to a human-machine interface (HMI) control block 211. The local network interface section 202 supports execution of the software based on the distributed object model. In addition, it performs communication processes for node-to-node communications via the network. Specifically, the local network interface section 202 is configured by three blocks, namely an NIC (i.e., Network Interface Card) block 220, a network protocol process block 221, and a distributed object interface block 222. Herein, the NIC block 220 performs processing with respect to a physical layer and a part of a data link layer in an OSI (i.e., Open System Interconnection) reference model. The network protocol process block 221 performs processing with respect to the narrowly-defined network protocol that contains a part of the data link layer, a network layer and a transport layer. The distributed object interface block 222 operates as an execution basis for the distributed object system and is configured by the software (or normal program).

The display process section 203 provides an execution of display processes by a display output and is configured by two blocks, namely a decoding process block 231 and an display block 230 that performs the display operations. Herein, complicated processes and processes that need access to the information resources within the display processes are sent to the service node via the network wherein they are subjected to processing. Processing results are received and are subjected to decoding process by the decoding process block 231. The sound signal input process section 204 provides a sound input for inputting speech signals or sound signals, and it is configured by two blocks, namely a coding process block 241 and an analog-to-digital conversion block 240. Herein, complicated processes such as the speech recognition and processes that need access to the information resources are sent to the application node via the network, wherein they are subjected to coding process by the coding process block 241. The analog-to-digital conversion block 240 inputs and digitizes speech signals or sound signals. The sound signal output process section 205 provides a sound output for outputting speech signals or sound signals, and it is configured by two blocks, namely a decoding process block 251 and a digital-to-analog conversion block 250. Herein, complicated processes such as the speech synthesis from the text and processes that need access to the information resources are sent to the application node via the network, wherein they are subjected to decoding process by the decoding process block 251. The digital-to-analog conversion block 250 converts digital signals, output from the decoding process block 251, to analog signals.

In the aforementioned blocks, the decoding process block 231, coding process block 241 and decoding process block 251 are respectively connected with the HMI control block 211 by way of communication lines or paths 232, 242 and 252, which are realized by the hardware or software. The present embodiment is designed in such a manner that data processes for the human-machine interface are executed by the same processing system or its substitute system. Each of the devices 101 to 103 is configured by the prescribed elements for use in transmission and reception of data between their processing systems, namely the human-machine interface (HMI) control block 211, display process section 203, sound signal input process section 204 and sound signal output process section 205. It is possible to commonly share these elements between the devices 101 to 103 with ease. That is, by introducing the common specification for interfaces between the devices, it is possible to commonly share information regarding operations of the human-machine interfaces between the devices. Hence, it is possible to obtain the same feeling for manipulation among the different devices.

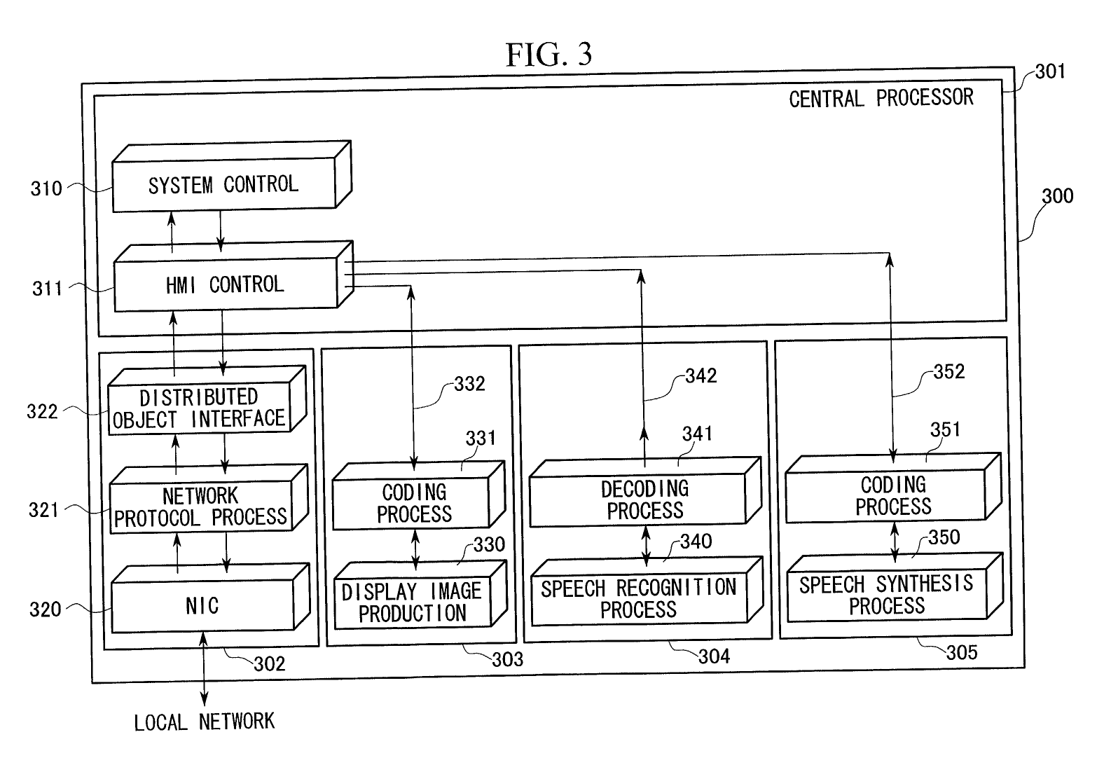

FIG. 3 shows an internal configuration of a service node 300 that corresponds to the service node 104 shown in FIG. 1. Internal functions of the service node 300 are actualized independently or integrated together by means of a CPU, a DSP and a storage device as well as the hardware such as an interface and its software. Specifically, the service node 300 is configured by an integrated control section (or a central processor) 301, a local network interface section 302, a display process section 303, a sound signal input process section 304, and a sound signal output process section 305. Herein, the display process section 303, sound signal input process section 304 and sound signal output process section 305 are not necessarily installed in the service node 300. Hence, it is possible to provide one or two of them in the service node 300, or it is possible to provide multiple series of the same section in the service node 300. Outline operations of these sections will be described below.

A system control block 310 plays a central role for the integrated control section 301. It issues macroinstructions or monitors states of a human-machine interface (HMI) control block 311. The local network interface section 302 supports execution of the software based on the distributed object model. In addition, it performs communication processes for node-to-node communications via the network. Specifically, the local network interface section 302 is configured by three blocks, namely an NIC block 320, network protocol process block 321 and a distributed object interface block 322. The NIC block 320 performs processes with respect to a physical layer and a part of a data link layer. The network protocol process block 321 performs processes with respect to the narrowly-defined network protocol that contains a part of the data link layer, a network layer and a transport layer. The distributed object interface block 322 operates as an execution basis for the distributed object system. The display process section 303 provides an execution of display processes and is configured by two blocks, namely a coding process block 331 and a display image production block 330. Herein, the coding process block 331 performs complicated processes or processes that need access to the information resources in the display processes, so that processed results are sent out via the network. The display image production block 330 produces display images. The sound signal input process section 304 provides a sound input for inputting speech signals or sound signals, and it is configured by two blocks, namely a decoding process block 341 and a speech recognition process block 340. To perform complicated processes such as the speech recognition and processes that need access to the information resources, speech signals or sound signals are sent to the service node 300 via the network, wherein they are subjected to decoding process by the decoding process block 341. The speech recognition process block 340 performs a speech recognition process on outputs of the decoding process block 341. The sound signal output process section 305 provides a sound output for outputting speech signals or sound signals, and it is configured by two blocks, namely a coding process block 351 and a speech synthesis process block 350. Results of complicated processes such as the speech synthesis from the text and processes that need access to the information resources are subjected to coding process by the coding process block 351 and are sent out via the network. The speech synthesis process block 350 performs a speech synthesis process on outputs of the coding process block 351.

In the aforementioned blocks, the coding process block 331, decoding process block 341 and coding process block 351 are connected with the HMI control block 311 by way of communication lines or paths 332, 342 and 352, which are realized by the hardware or software.

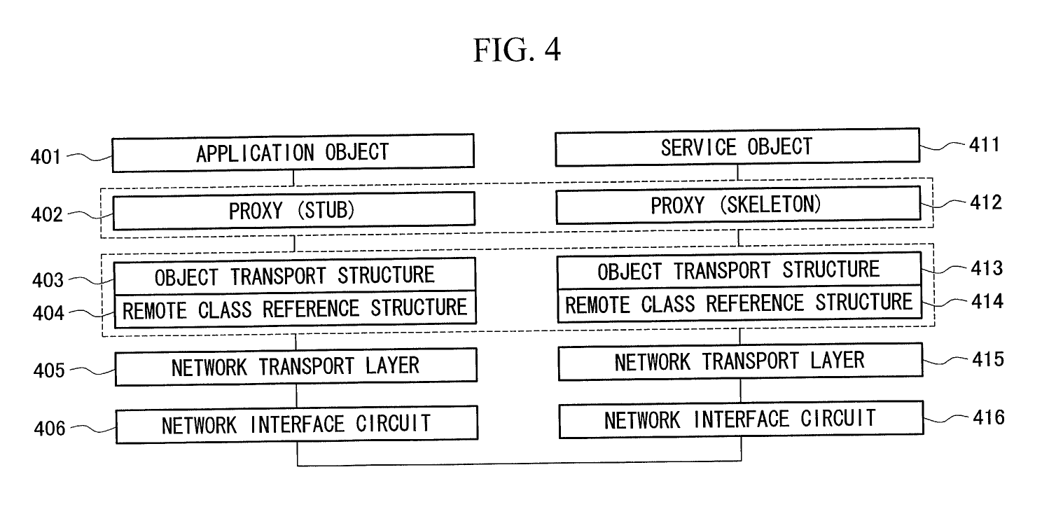

FIG. 4 shows an example of a software execution structure based on the distributed object model, which is adopted for the human-machine interface system in accordance with the embodiment of the present invention. Herein, six blocks 401 to 406 are defined for the application node 200 shown in FIG. 2, and another six blocks 411 to 416 are defined for the service node 300 shown in FIG. 3. Specifically, an application object 401 corresponds to the display process section 203, sound signal input process section 204 and sound signal output process section 205, while blocks 402 to 406 correspond to the local network interface section 202. In addition, blocks 412 to 416 correspond to the local network interface section 302, while a service object 411 corresponds to the display process section 303, sound signal input process section 304 and sound signal output process section 305.

As shown in FIG. 4, the application object 401 is connected with the blocks 402-406 that are placed in lower layers, while the service object 411 is connected with the blocks 412-416 that are placed in lower layers. Therefore, the application object 401 calls the service object 411 by using the lower layers to transparently execute it. Specifically, a stub 402 is connected with the application object 401 as its lower layer, while a skeleton 412 is connected with the service object 411 as its lower layer. The stub 402 and skeleton 412 act as proxies for their local hosts in calling processes, by which the aforementioned ‘transparent’ execution is to be realized. Object transport structures 403 and 413 provide transport functions on the network for reference of objects. Remote class reference structures 404 and 414 provide functions for reference of classes that are distributed on the network. Network/transport layers 405 and 415 provide an ‘open’ communication basis having high extensibility by performing communication processes in their layers respectively. Network interface circuits 406 and 416 provide electric signals for construction of the network by processing the physical layer and a part of the data link layer.

The distributed object interface 222 shown in FIG. 2 is divided into two portions, namely an upper portion that depends upon the configuration of the application object 401 and a lower layer that does not depend upon it. Similarly, the distributed object interface 322 shown in FIG. 3 is divided into two portions, namely an upper portion that depends upon the configuration of the service object 411 and a lower layer that does not depend upon it. The proxy (or stub) 402 corresponds to the upper portion of the distributed object interface 222, while the proxy (or skeleton) 412 corresponds to the upper portion of the distributed object interface 322. In addition, the object transport structure 403 and remote class reference structure 404 correspond to the lower portion of the distributed object interface 222 that does not depend upon the configuration of the application object 401. Similarly, the object transport structure 413 and remote class reference structure 414 correspond to the lower portion of the distributed object interface 322 that does not depend upon the configuration of the service object 411. The network/transport layers 405 and 415 are used to perform network protocol processes with regard to TCP/IP (i.e., ‘Transmission Control Protocol/Internet Protocol’), for example. Specifically, the network/transport layers 405 and 415 correspond to the network protocol process blocks 221 and 321 shown in FIGS. 2 and 3 respectively. The network interface circuits 406 and 416 correspond to the NIC blocks 220 and 320 shown in FIGS. 2 and 3 respectively. Within the aforementioned lower layers, only the stub 402 and skeleton 412 are to depend upon the configurations of the application object 401 and service object 411. Other layers such as the object transport structures 403, 413 through the network interface circuits 406, 416 are not to depend upon the configurations of the application object 401 and service object 411.

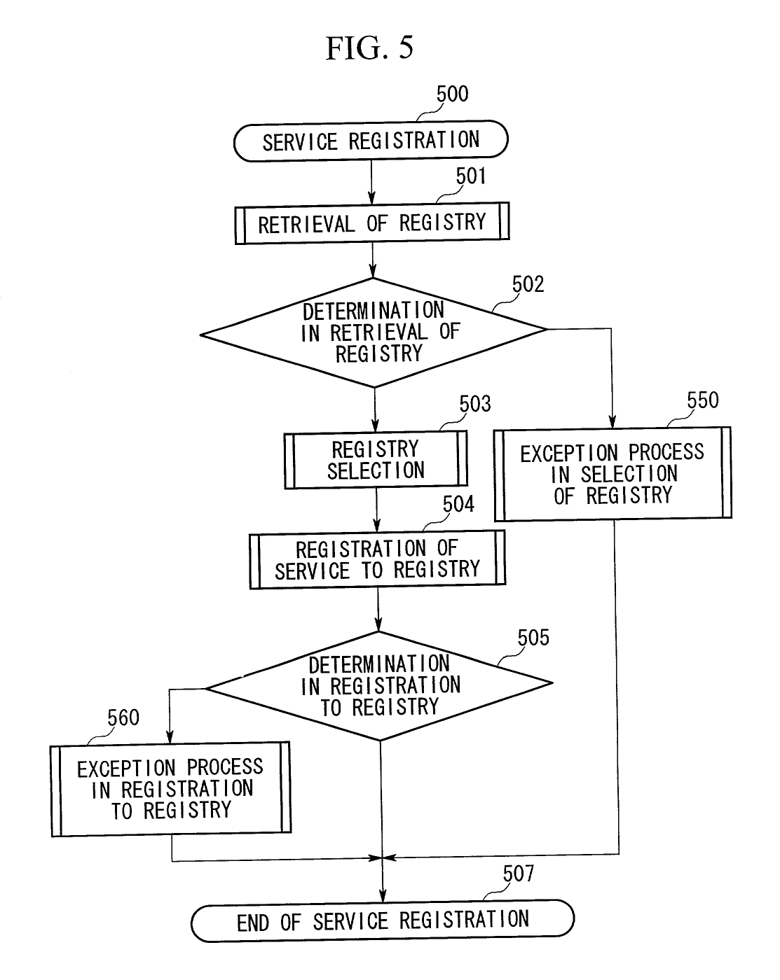

Next, operations of the human-machine interface system of the present embodiment will be described with reference to flowcharts shown in FIGS. 5, 6, 7A, 7B, 8A and 8B. First, the existence of objects should be registered in registries of the network by a service registration process shown in FIG. 5 in order that one or plural service objects (e.g., service object 411 that provides services) can use one or plural applications (e.g., application object 401). Upon starting the service registration process of FIG. 5, the flow firstly proceeds to step 501 in which the started service object retrieves a desired registry within the registries existing in the network. In step 502, a determination is made as to whether the retrieved registry meets the prescribed registration requirement or not. If ‘NO’, the flow proceeds to step 550 to perform an exception process in registry selection so that registration is not performed. If there exists a ‘registrable’ registry in the network, the service object chooses candidates for the registries, from which it selects a registry that is actually used for registration in step 503. In step 504, the service object is registered with the selected registry. In step 505, a confirmation is made as to registration with the registry. If any abnormality is found in registration, the flow proceeds to step 560 in which a registration exception process is performed. Then, the service registration process is ended with an error or abnormality. If it is confirmed that the service object is normally registered with the registry without abnormality, the service registration process is ended without an error or abnormality in step 507.

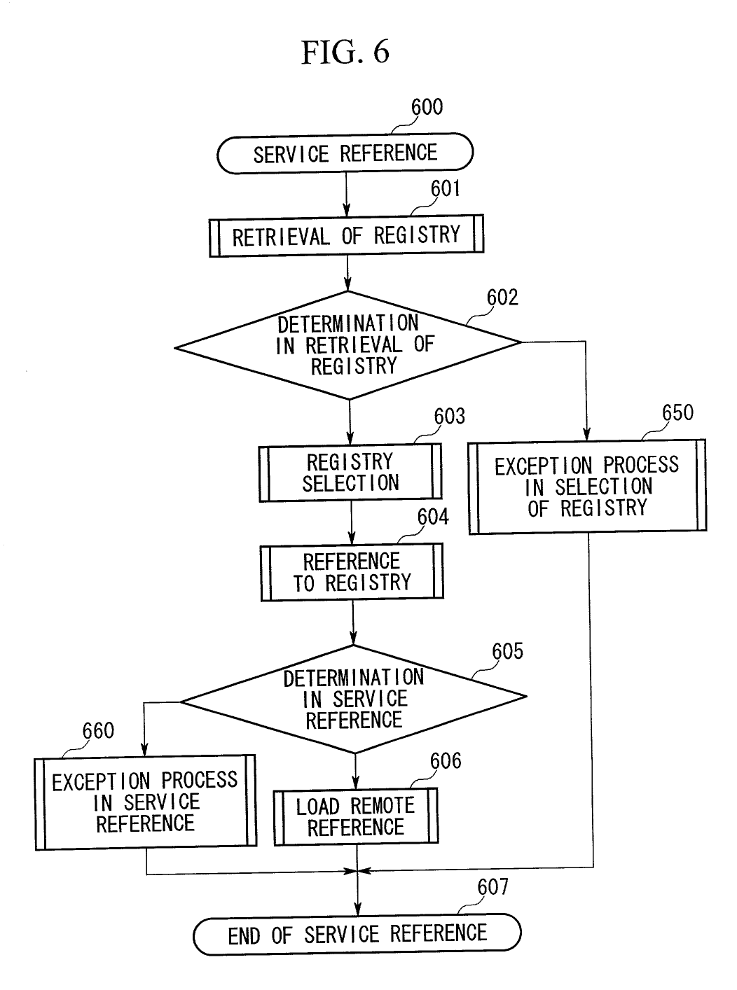

Next, a description will be given with respect to a service reference process shown in FIG. 6 in which an application object is going to use a (target) service. In FIG. 6, the flow firstly proceeds to step 601 in which the application object retrieves a desired registry within registries existing in the network. In step 602, a determination is made as to whether the retrieved registry registers the ‘target’ service or not. If the application object fails to find out any registries within the scope of the network, the flow proceeds to step 650 in which a selection exception process is performed. Then, the service reference process is ended with an error or abnormality. If the application object succeeds in finding some registries within the scope of the network, the flow proceeds to step 603 in which the application object selects a registry from among the registries. In step 604, reference is made to content (i.e., registered service) of the selected registry. In step 605, a decision is made as to whether the reference is made without an error or not. If an error is found, the flow proceeds to step 660 in which an exception process in service reference is performed. Then, the service reference process is ended with an error or abnormality. If no error is found, the application object loads a remote reference in step 606. Then, the service reference process is normally ended without an error or abnormality.

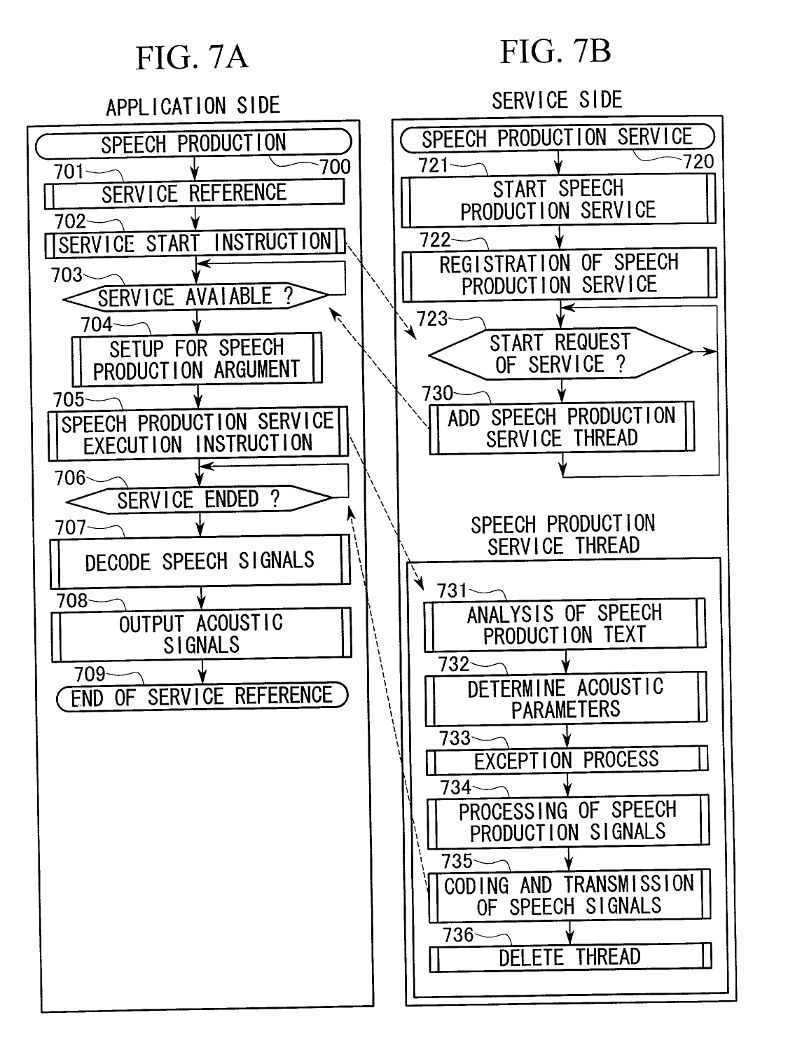

Next, a description will be given with respect to a concrete example of the service on the network, namely a speech production service with reference to FIGS. 7A and 7B. That is, FIG. 7A shows steps for an application side corresponding to the application object 401, and FIG. 7B shows steps for a service side corresponding to the service object 411. Specifically, the application side performs a speech production process of step 700, while the service side correspondingly performs a speech production service process of step 720. Herein, the speech production service advances with interaction between the application side and service side. First, the application side performs the service reference process of FIG. 6 with respect to the speech production service in step 701. In step 702, the application side issues a use start instruction (or start request) for the speech production service. On the other hand, the service side starts the speech production service in step 721, so that the speech production service is registered by the service registration process of FIG. 5 in step 722. Then, the service side waits for a start request of the speech production service in step 723. Upon receipt of a start request that is issued by the application side in step 702, the flow proceeds from step 723 to step 730 so that the service side additionally starts a ‘thread’ for execution of a new speech production program. Then, the service side returns a response to the application side. In step 703, the application side is in a standby state waiting for the response from the service side. The standby state is sustained until the application side acknowledges based on the response that the speech production service is ready to be started or until an end of the prescribed time corresponding to a timeout. In step 704, the application side sets an argument for the speech production service. In step 705, the application side issues an execution instruction for the speech production service. Then, the application side is in a standby state waiting for transmission of results of the speech production service in step 706. Incidentally, the host of the application side is capable of executing other processes during the standby state.

Upon receipt of the execution instruction of the speech production service from the application side, the service side analyzes a speech production text that is designated by the argument in step 731, which is embedded within the speech production service thread shown in FIG. 7B. Through analysis, the service side determines acoustic parameters to obtain time series parameter strings in step 732. Upon detection of an error that causes a trouble in production of the time series parameter strings, the service side performs an exception process in step 733. Then, speech waveform data (or speech production signals) are created based on the time series parameter strings in step 734. In step 735, the speech waveform data are subjected to coding process to adjust data forms, and then they are transmitted to the application side as execution results of the speech production service. After completion of the aforementioned processing of steps 731-735, the service side deletes the thread in step 736. The application side, which is temporarily in the standby state in step 706, receives the execution results of the speech production service. Thus, the application side decodes speech signals based on the execution results in step 707. In step 708, the application side produces acoustic signals, which are output therefrom or which are transferred to another application.

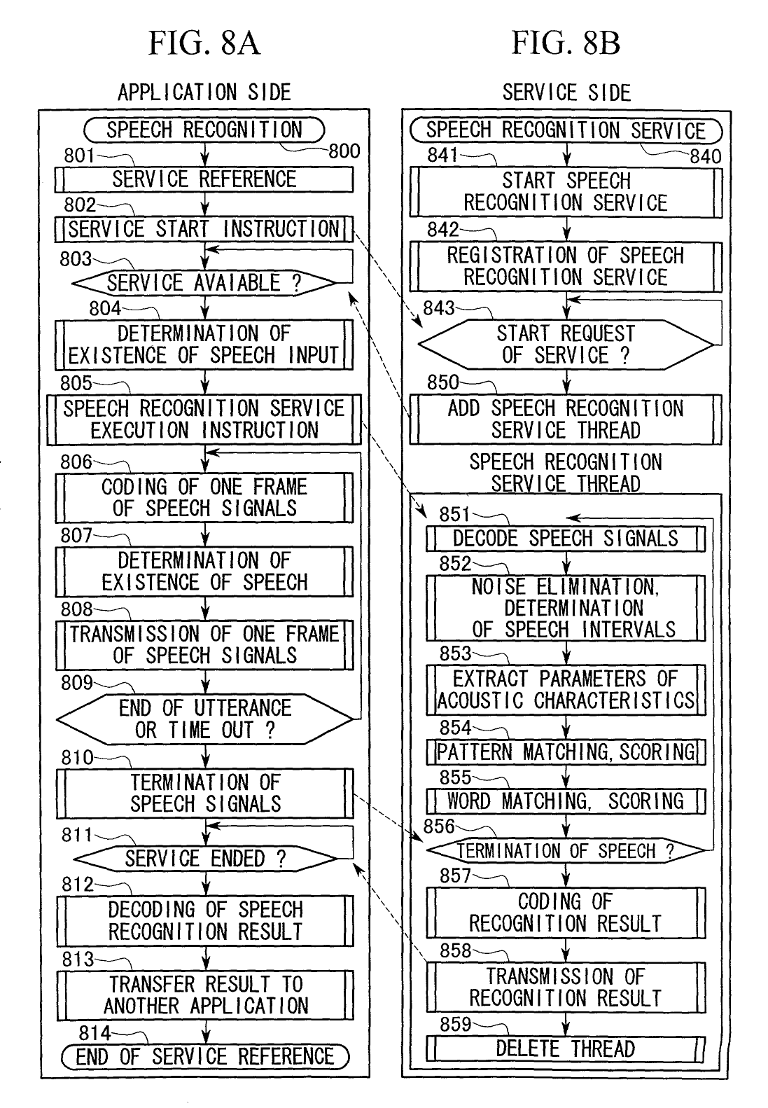

Next, a description will be given with respect to another concrete example of the service on the network, namely a speech recognition service with reference to FIGS. 8A and 8B. That is, FIG. 8A shows a speech recognition process of step 800 that is performed by an application side, and FIG. 8B shows a speech recognition service process of step 840 that is performed by a service side. Herein, the speech recognition service advances with interaction between the application side and service side. First, the application side performs a service reference process of FIG. 6 with respect to the speech recognition service in step 801 shown in FIG. 8A. In step 802, the application side issues a use start instruction (or start request) for the speech recognition service. On the other hand, the service side starts the speech recognition service process in step 841 shown in FIG. 8B. In step 842, the service side performs a service registration process of FIG. 5 with respect to the speech recognition service. In step 843, the service side waits for receipt of a start request of the speech recognition service. Upon receipt of the start request of the speech recognition service from the application side (see step 802), the service side additionally starts a thread for a new speech recognition program in step 850. Then, the service side returns a response to the application side. In step 803, the application side is in a standby state waiting for the response from the service side. The standby state is sustained until the application side acknowledges based on the response that the speech recognition service is ready to be started or until an end of the prescribed time corresponding to a timeout. In step 804, the application side performs a determination in existence of a speech input in order to roughly and acoustically detect a start of the speech recognition. In step 805, the application side issues a start instruction for the speech recognition service. In step 806, the application side performs coding processes on speech signals by prescribed units of frames respectively, for example, by every one frame. In step 807, the application side performs a determination of the existence of speech. In step 808, the application side transmits resultant speech signals to the service side. In step 809, the application side is put into a standby state waiting for detection of an end of utterance of speech or waiting for an elapse of the prescribed time corresponding to a timeout. Thus, the application side repeatedly performs the aforementioned steps 806 to 808 until the application side leaves the standby state of step 809. Upon detection of an end of the utterance of speech or an end of the elapse of the prescribed time, the flow proceeds to step 810 in which the application side communicates termination of the speech signals to the service side.

Upon receipt of the execution instruction of the speech recognition service from the application side (see step 805), the service side proceeds to a first step 851 of the speech recognition service thread shown in FIG. 8B, wherein it decodes the speech signals. In step 852, the service side performs elimination of environmental noise and determination for a more accurate speech interval. In step 853, the service side extracts parameters of acoustic characteristics from the decoded speech signals. In step 854, the service side performs pattern matching using its own dictionary registering parameters of acoustic characteristics, by which it chooses candidates for match between the registered parameters and extracted parameters. Thus, the service side successively performs scoring processes on the chosen candidates. In step 855, the service side performs word matching using a word dictionary registering prescribed words for use in speech recognition, so that it chooses some of the registered words that possibly match spoken words corresponding to the speech signals. Thus, the service side selects one of the chosen words that has a highest likelihood in word matching. In step 856, the service side makes a decision as to whether it detects termination of the speech signals, an end of a speech interval or occurrence of a timeout. Thus, the service side repeatedly performs the aforementioned steps 851 to 855 until the service side leaves from the decision step 856. Thereafter, the flow proceeds to step 857 in which the service side effects coding processes on results of the speech recognition service, which are then transmitted to the application side as execution results of the speech recognition service in step 858. After completion of the speech recognition service, the service side deletes the thread in step 859. Upon receipt of the execution results of the speech recognition service from the service side, the application side leaves from the standby state of step 811 shown in FIG. 8A. Then, the flow proceeds to step 812 in which the application side decodes the execution results of the speech recognition service. In step 813, the application side further processes the execution results or transfers them to another application.

As described above, the human-machine interface system of the first embodiment has various effects, which will be described below.

(1) A first effect is to reduce the cost per each device for use in the human-machine interface system that is actualized on the network. In general, devices interconnected together with the network may be used for multiple purposes or simultaneously used for the same purpose. Private devices generally have very low degrees of multiplicity in use therebetween. In other words, it is possible to set the number of services individually used for the human-machine interfaces to be very small as compared with the number of private devices interconnected with the network. For example, a ratio between these numbers can be set to 10%.

(2) A second effect is to raise or improve functions and performance of the devices interconnected with the network. One reason is to reduce the cost per each device for use in the human-machine interface system. Other reasons are to avoid hardware restrictions of the devices that are caused by power capacities and heat radiation capacities as well as prescribed shapes of casing.

(3) A third effect is to provide the same feeling of manipulation between the different devices that can commonly share the operation information of the human-machine interface system actualized on the network. This is because the processing of the human-machine interface system is performed by the same processing system of the network or its substitute system.

(4) A fourth effect is to ensure flexible extension of the human-machine interface system on the network. This is because it is possible to continuously use the original environment for hardware and software resources in spite of needs for updating the processing of the human-machine interface system. For example, a higher processing performance can be easily achieved by reducing degrees of multiplicity in use of services for the human-machine interface system or by newly adding nodes having special hardware resources of high performance. Because of the aforementioned reasons, it is possible to reduce the initial cost for installation and introduction of the human-machine interface system.

(5) A fifth effect is that the devices can commonly share the high-order information processing of human-machine interfaces that are actualized by different expression media. Herein, the high-order information processing correspond to processes for the common text related to both of the speech information and character information and processes based on semantics, for example. The present embodiment is characterized by installing the high-order information processing in the network as independent services.

### Second Embodiment

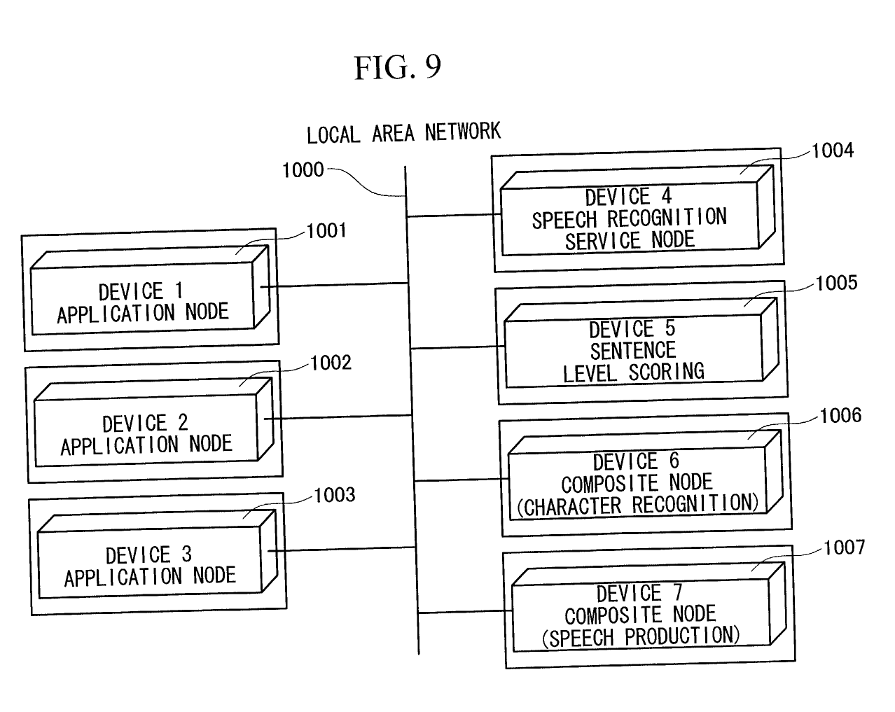

Next, descriptions will be given with respect to a human-machine interface system in accordance with a second embodiment of the invention. FIG. 9 shows a human-machine interface system in accordance with a second embodiment of the invention that is applied to a local area network (or simply referred to as a ‘local network’) 1000 which interconnects together seven devices (or nodes) 1001 to 1007. Herein, three devices 1001, 1002 and 1003 correspond to application nodes, and one device 1004 corresponds to a speech recognition service node. In addition, a device 1005 performs a scoring process at a sentence level, and the remaining two devices 1006 and 1007 correspond to composite nodes. Specifically, the device 1006 shares functions of a character recognition node and an application node, and the device 1007 shares functions of a speech production service node and an application node.

Next, a description will be given specifically with respect to outline contents of functions of the aforementioned devices 1001 to 1007 that are interconnected together on the local area network 1000 shown in FIG. 9. The devices 1001, 1002 and 1003 perform applications specifically allocated thereto. In addition, these devices also provide front-end functions for human-machine interfaces, which are manipulated by human users. The device 1004 provides a back-end function for speech recognition within human-machine interface functions of the devices 1001, 1002 and 1003. The device 1005 provides comparison with respect to the high-order hierarchy that does not depend upon expression media within the human-machine interface functions of the devices 1001-1003. In addition, it also provides a scoring function based on comparison result. The device 1006 provides a back-end function for character recognition within the human-machine interface functions of the devices 1001-1003. In addition, it also performs an application specifically allocated thereto. The device 1007 provides a back-end function for speech production within the human-machine interface functions of the devices 1001-1003. In addition, it also performs an application specifically allocated thereto.

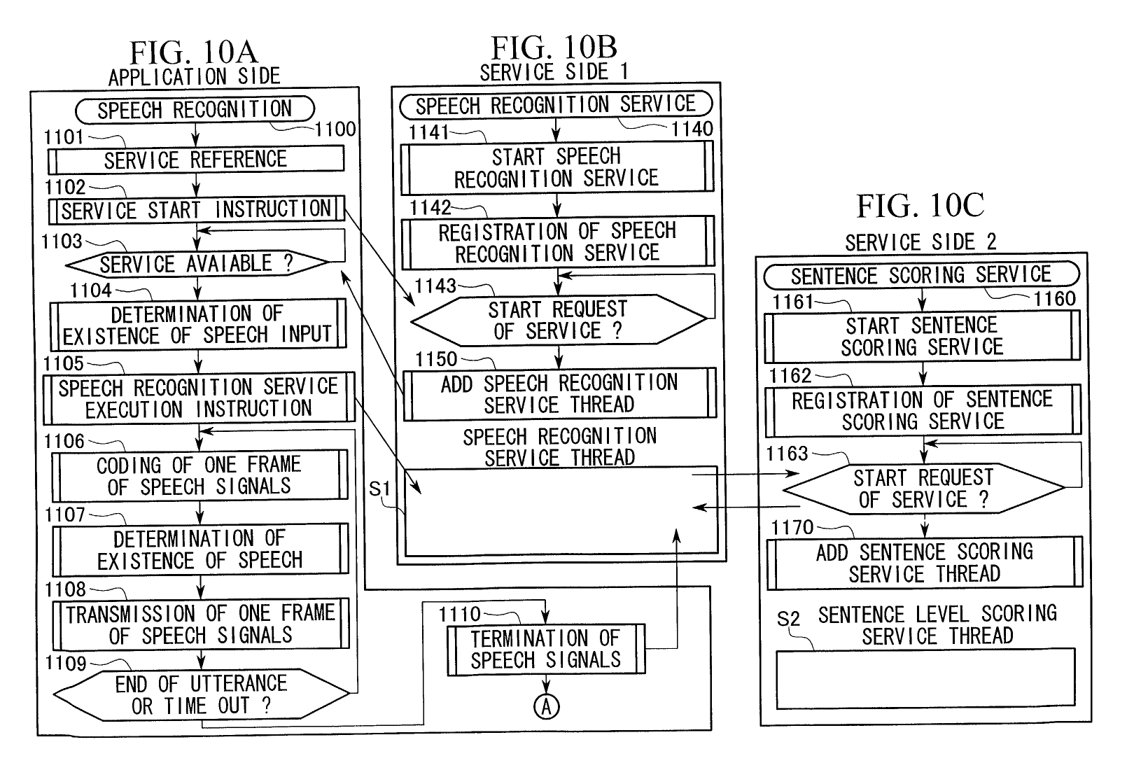

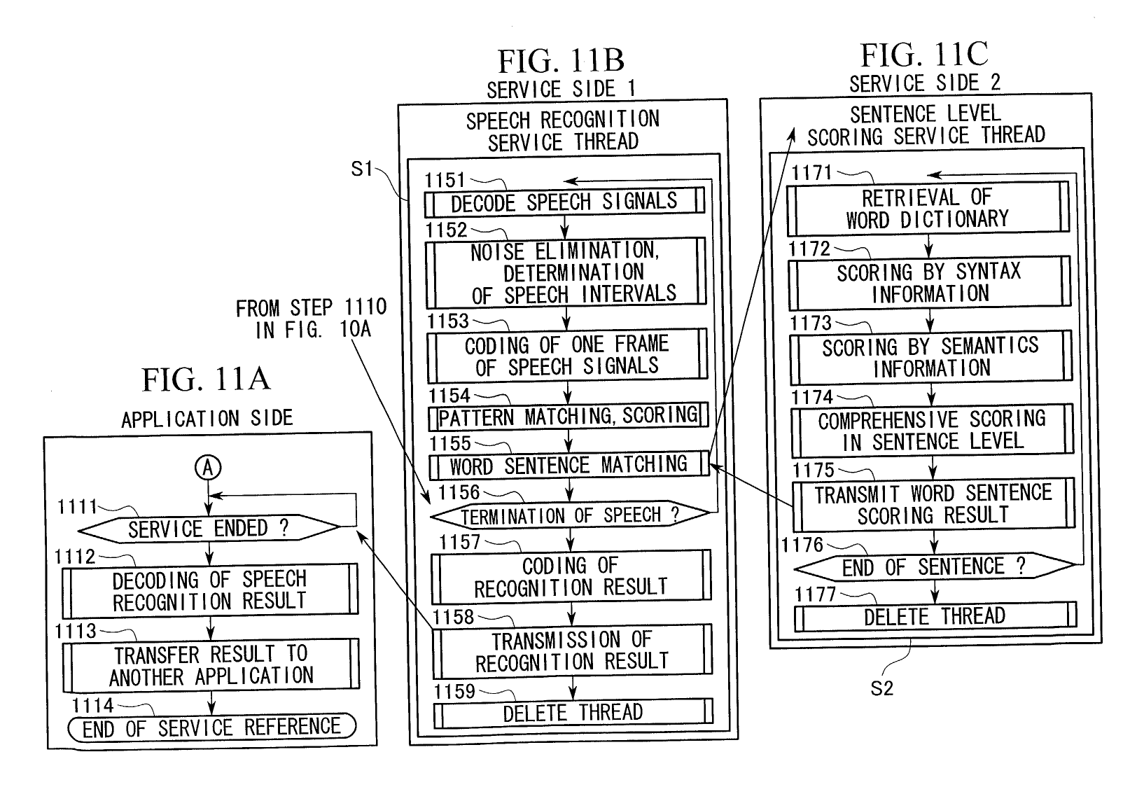

With reference to FIGS. 10A, 10B, 10C, and FIGS. 11A, 11B, 11C, descriptions will be given with respect to contents of services regarding speech recognition and sentence level scoring in detail. A series of steps shown in FIG. 10A are connected to a series of steps shown in FIG. 11A by way of a connection mark ‘A’. In addition, a series of steps shown in FIG. 11B show details of a speech recognition service thread ‘S1’ shown in FIG. 10B, and a series of steps shown in FIG. 11C show details of a sentence level scoring service thread ‘S2’ shown in FIG. 10C. An application side that corresponds to any one of the devices 1001-1003 performs a speech recognition process of step 1100, details of which are shown in FIGS. 10A and 11A. A service side ‘1’ that corresponds to the device 1004 performs a speech recognition service process of step 1140, details of which are shown in FIGS. 10B and 11B. Another service side ‘2’ that corresponds to the device 1005 performs a sentence level scoring service process, details of which are shown in Figures 10C and 11C. Herein, the speech recognition, speech recognition service and sentence level scoring service advance with interaction between the application side, service side 1 and service side 2.

When the application side starts the speech recognition process of step 1100 shown in FIG. 10A, the flow proceeds to step 1101 in which a service reference process of FIG. 6 is performed with respect to the speech recognition service. In step 1102, the application side sends a start instruction (or start request) for the speech recognition service to the service side 1. On the other hand, the service side 1 starts the speech recognition service process in step 1141 shown in FIG. 10B. In step 1142, the service side 1 performs a service registration process of FIG. 5 so that the speech recognition service is registered with some registry. In step 1143, the service side 1 is put into a standby state waiting for receipt of a start request of the speech recognition service. Upon receipt of the start request from the application side, the service side 1 additionally starts a speech recognition service thread ‘S1’ for a new speech recognition program in step 1150. Then, the service side returns a response to the application side. In step 1103, the application side is in a standby state waiting for a response from the service side 1. The standby state is sustained until the application side acknowledges based on the response that the speech recognition service is ready to be started or until an end of the prescribed time corresponding to a timeout. In step 1104, the application side performs a determination of the existence of a speech input to roughly and acoustically detect a start of speech recognition. In step 1105, the application side makes an execution instruction for the speech recognition service. In step 1106, the application side performs coding processes on speech signals by prescribed units of frames, for example, by every one frame. In step 1107, the application side performs a determination of the existence of speech. In step 1108, the application side transmits resultant speech signals to the service side 1. In step 1109, the application side is put into a standby state waiting for detection of an end of utterance or detection of an elapse of the prescribed time corresponding to a timeout. Thus, the application side repeatedly performs the aforementioned steps 1106, 1107 and 1108 until it detects an end of the utterance or until an elapse of the prescribed time corresponding to the timeout. If detected, the flow proceeds to step 1110 in which the application side sends termination of the speech signals to the service side 1.

Upon receipt of a start request of the speech recognition service from the application side, the service side 1 leaves from the standby state of step 1143, so that it additionally performs the speech recognition service thread ‘S1’, details of which are shown in FIG. 11B. That is, the flow proceeds to step 1151 in which the service side 1 decodes the speech signals. In step 1152, the service side 1 performs elimination of environmental noise and determination of more accurate speech intervals. In step 1153, the service side 1 extracts parameters of acoustic characteristics from the speech signals. In step 1154, the service side 1 performs pattern matching using its own dictionary registering parameters of acoustic characteristics, so that it chooses candidates for matching between the extracted parameters and registered parameters. In addition, it successively performs scoring processes with respect to the candidates. In step 1155, the service side 1 performs pattern matching using a word dictionary, so that it chooses some words that are registered in the word dictionary and that possibly match words corresponding to the speech signals. In addition, the service side 1 performs scoring processes to select a word having a highest likelihood within the chosen words. In step 1156, the service side 1 makes a decision as to whether it detects termination of the speech signals, an end of the speech interval or occurrence of a timeout. Thus, the service side 1 repeatedly performs the aforementioned steps 1151 to 1155 until it leaves from the decision step 1156. Therefore, the service side 1 obtains a word (or words) that highly matches the input speech signals. Herein, it is possible to obtain results of the speech recognition that is performed at the word level or so. These results are sent to the service side 2 that provides a sentence level scoring service in step 1160. In this case, the service side 2 has already started a sentence level scoring service process in step 1161. In step 1162, the service side 2 performs a service registration process of FIG. 5 to register the sentence level scoring service with the registry. In step 1163, the service side 2 is put into a standby state waiting for reception of a start request of the sentence level scoring service. Upon receipt of the start request from the service side 1, the service side 2 additionally starts a sentence level scoring service thread ‘S2’ in step 1170.

In the sentence level scoring service thread S2 shown in FIG. 11C, the flow firstly proceeds to step 1171 in which the service side 2 retrieves words from the word dictionary. In step 1172, the service side 2 performs scoring processes on the retrieved words based on syntax information. In step 1173, the service side 2 also performs scoring processes on the retrieved words based on semantic information. Thus, the service side 2 performs comprehensive scoring processes on the retrieved words in the sentence level in step 1174. Thus, the service side 2 produces results of word sentence scoring processes, which are transmitted to the service side 1 in step 1175. The service side 2 repeatedly performs the aforementioned steps 1171 to 1175 until it detects an end of the sentence containing the retrieved words that are subjected to the scoring processes in step 1176. Upon detection of an end of the sentence, the service side 2 deletes the sentence level scoring service thread S2 in step 1177. When the service side 1 detects an end of utterance in step 1156, the flow proceeds to step 1157 in which a coding process is effected on result of the speech recognition, which is then sent to the application side as an execution result of the speech recognition service in step 1158. In step 1159, the service side 1 deletes the speech recognition service thread S1 that is completed in processing. Thus, the application side leaves from the standby state of step 1111 waiting for receipt of the execution result of the speech recognition service from the service side 1. Therefore, the flow proceeds to step 1112 in which a decoding process is effected on the execution result of the speech recognition service, which is then further processed and transferred to another application in step 1113.

### Third Embodiment

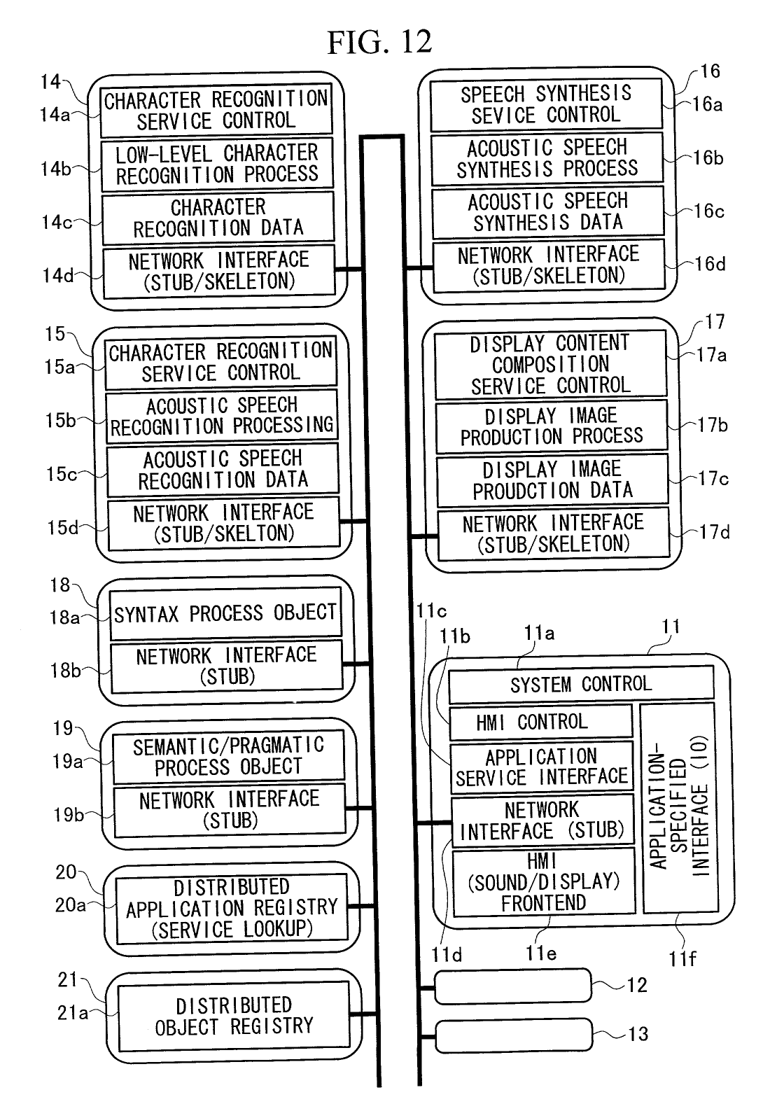

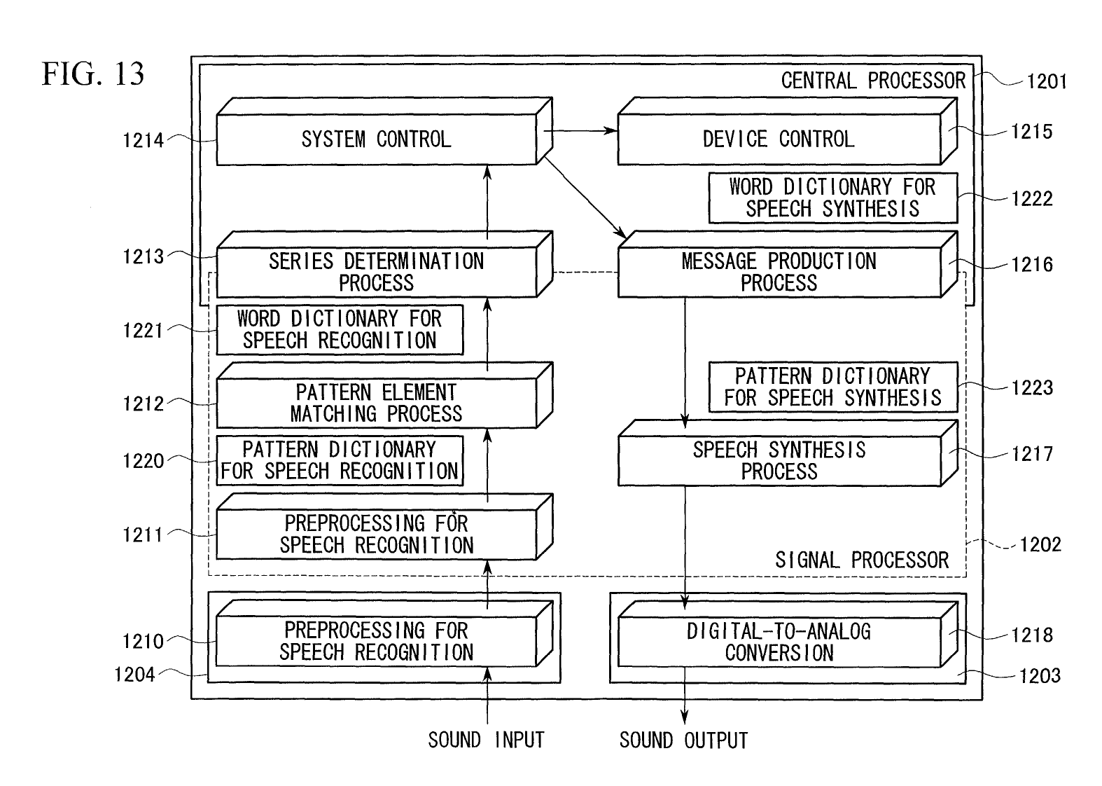

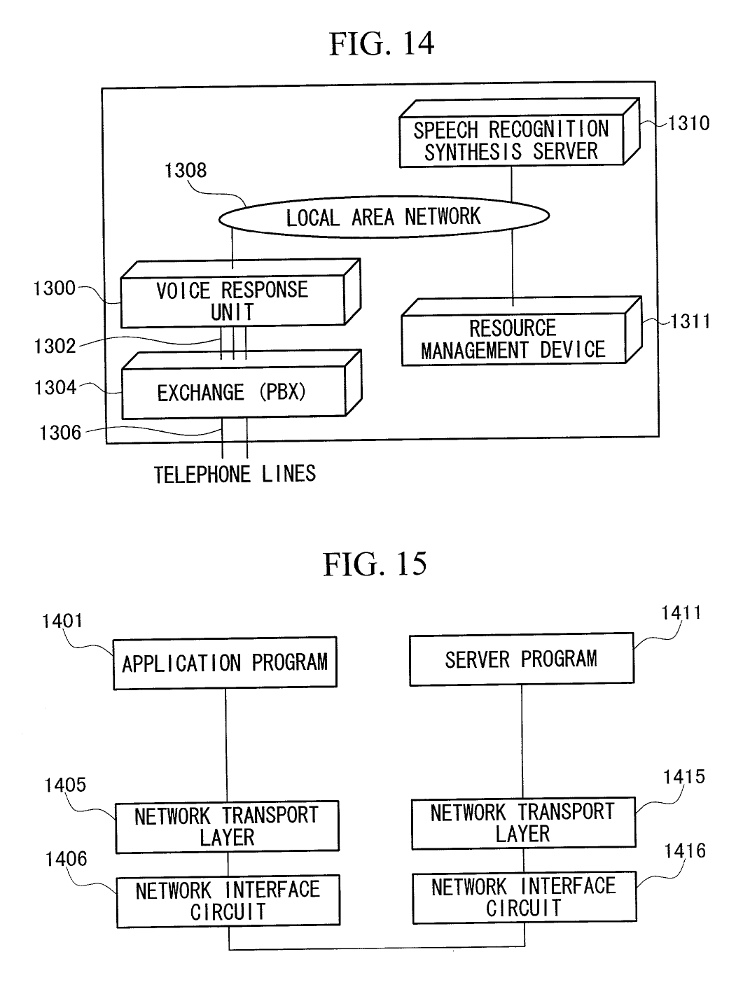

With reference to FIG. 12, descriptions will be given with respect to a human-machine interface system in accordance with a third embodiment of the invention. That is, FIG. 12 shows a local area network (LAN) 10 that actualizes the human-machine interface system to provide vocalized responses by speech recognition and text display by characters. As hardware elements, the local area network 10 interconnects together eleven nodes, that is, three hosts 11 to 13 corresponding to application nodes, and six hosts 14 to 19 corresponding to service nodes as well as other two hosts 20 and 21. Herein, the host 20 provides a registry with respect to application services, and the host 21 provides a registry with respect to distributed objects. That is, these hosts 20 and 21 act as registry nodes. Incidentally, the registry nodes are not necessarily provided independently of the application nodes and service nodes. Hence, it is possible to realize functions of the registry nodes in the hosts that originally act as the application nodes and/or service nodes. In addition, it is possible to dynamically change functions of the application nodes and service nodes allocated to the hosts. In other words, it is not always required that entities regarding the distributed object and distributed service are not necessarily executed on the different hosts. For example, it is necessary to consider a situation in which the object originally allocated to one host is transferred to and executed in another host on the network. In addition, the human-machine interface system of the third embodiment is not necessarily applied to the local area network. Hence, it can be applied to another type of the network having a sub-network as long as the network meets the prescribed conditions regarding the bandwidth and transmission delay allowed by the application.

First, a description will be given with respect to the application nodes that correspond to the hosts 11 to 13 shown in FIG. 12. All of the hosts 11-13 are configured similarly, hence, a description will be given with respect to only an internal configuration of the host 11. The host 11 contains six layers, namely a system control 11a, an HMI control 11b, an application service interface 11c, a network interface (stub) 11d, an HMI (sound/display) front-end 11e, and an application-specified interface (IO) 11f. Due to the aforementioned configuration, each of the hosts 11 to 13 acts as an application node under the human-machine interface service on the network. Thus, it provides various functions such as inputting commands by human voices, replying vocalized responses and displaying statuses with respect to the human-machine interface system. Other than the functions of the human-machine interface system, the application nodes (i.e., hosts 11-13) have controls and input/output functions (specially realized by the application-specified interface 11f) suited thereto. The application node provides the application service interface 11c and network interface 11d for the purpose of the distributed application interface thereof. In addition, the HMI control 11b brings integration and coordination of the human-machine interface of the application node. The HMI front-end 11e performs access and control for a local device that is placed under control of the human-machine interface of the application node. In addition, it also performs signal conversion using coding techniques and the like. In the above, the human-machine interface realizes the prescribed expression media such as sound and display. It is possible to use other expression media for the human-machine interface. In that case, the layered structure of the application node should be changed in response to the type of the expression media that is actually used for the human-machine interface. Incidentally, the system control 11a performs the integrated control on the functions of the application node.

Next, a description will be given with respect to application services and registries. As described before, the local area network 10 shown in FIG. 12 interconnects four service nodes (i.e., hosts 14-17) that provide application services to the application nodes (i.e., hosts 11-13). Specifically, there are provided a character recognition service node 14, a speech recognition service node 15, a speech synthesis (and vocalized response) service node 16, and a display content composition service node 17. The character recognition service node 14 contains four layers, namely a character recognition service control 14a, a low-level character recognition process 14b, a character recognition data 14c, and a network interface (stub/skeleton) 14d. The speech recognition service node 15 contains four layers, namely a speech recognition service control 15a, an acoustic speech recognition processing 15b, an acoustic speech recognition data 15c, and a network interface (stub/skeleton) 15d. The speech synthesis service node 16 contains four layers, namely a speech synthesis service control 16a, an acoustic speech synthesis process 16b, an acoustic speech synthesis data 16c, and a network interface (stub/skeleton) 16d. The display content composition service node 17 contains four layers, namely a display content composition service control 17a, a display image production process 17b, a display image production data 17c, and a network interface (stub/skeleton) 17d.

The service nodes 18 and 19 provides objects having functions corresponding to the high-order processing for the human-machine interfaces. That is, service node 18 provides a syntax process object 18a, and the service node 19 provides a semantic/pragmatic (or meaning/usage) process object 19a. In addition, the service node 18 has a network interface (stub) 18b that is used to provide the function of the syntax process object 18a, and the service node 19 has a network interface (stub) 19b that is used to provide the function of the semantic/pragmatic process object 19a. Incidentally, the human-machine interface system of the third embodiment is designed to commonly share the functions of the syntax process object 18a and semantic/pragmatic process object 19a between the nodes on the network. Therefore, these functions can be used in any one of the character recognition service control 14a, speech recognition service control 15a and speech synthesis service control 16a. The host 20 provides a distributed application registry 20a, and the host 21 provides a distributed object registry 21a. These registries act as locators for defining positions of the distributed object and distributed service.

Next, specific operations of the human-machine interface system of the third embodiment will be described with reference to FIG. 12.

(1) Registration of object and service

When the service nodes 14 to 19 are connected with the local area network 10, their services are registered with the distributed application registry 20a and the distributed object registry 21a. As typical types of registries, it is possible to employ the Java RMI (Remote Method Invocation) registry for the distributed application registry 20a, and it is possible to employ the Jini Lookup registry and the UPnP (Universal Plug and Play) SSDP (Simple Service Discovery Protocol) proxy for the distributed object registry 21a, wherein ‘Java’ and ‘Jini’ are both registered trademarks.

(2) Execution of HMI process

Suppose that the application node (e.g., host 11) on the network 10 performs an HMI process, for example, a speech recognition process. In this case, the application node 11 finds an application service (i.e., service node 15) on the network 10 with reference to the content of the distributed application registry 20a. Thus, the application node 11 proceeds to use start procedures, wherein it sends a start request of the application service and a datagram representing ‘coded’ speech information to the service node 15. Herein, the speech recognition service node 15 performs an acoustic matching process that exists locally in relation with the application service. In addition, it activates the syntax process object 18a and semantic/pragmatic process object 19a that are installed on the network 10, so that it performs a speech recognition process on an input speech sentence. Then, the service node 15 sends back a result of the speech recognition process to the application node 11 as a response. In the application node 11, the human-machine interface control 11b performs reception of a voice command and its related internal process as well as high-order processing such as determination of a sequence for vocalized responses.

(3) Vocalized response

The application node 11 transfers processing of vocalized responses to the speech synthesis service control 16a that provides a distributed application service on the network 10. Herein, the speech synthesis service node 16 performs ‘acoustic’ synthesis for the vocalized responses. In addition, it performs modifications in response to the syntax and semantics of the synthesized sentence by activating the syntax process object 18a and semantic/pragmatic process object 19a, which are installed on the network 10 and which allow production of vocalized responses in high quality.

(4) Production of display image

The application node 11 transfers processing regarding production of dialogues for the graphics/text display to the display content composition service control 17a that provides a distributed application service on the network 10. In terms of local processing, the network 10 does not have to provide a great amount of ‘fixed’ data such as fonts and graphic patterns, which are not necessarily duplicated between the nodes. In addition, the network 10 ensures production of the high-quality display content by applying relatively low loads to processors.

(5) Other applications

Other than the speech use, the human-machine interface system can be applied to checking of images and focus adjustment of cameras, for example. In addition, it is possible to improve performance in character recognition service, and it is possible to reduce the cost for actualization of the human-machine interface system on the network.

Like the aforementioned embodiments, the human-machine interface system of the third embodiment distributes functions of human-machine interfaces, which realize human-computer interaction for human operators (or human users) of devices, in the form of the distributed objects on the network. For example, the network 10 provides the speech recognition service control 15a and speech synthesis service control 16a for use in the speech recognition process and vocalized response process. Herein, these controls 15a and 16a perform low-order hierarchical processing with respect to the aforementioned processes. In addition, high-order hierarchical processing is performed using the syntax process object 18a and semantic/pragmatic process object 19a, which are provided commonly for the aforementioned processes. Thus, it is possible to share the common resources such as hardware elements, calculations and information that are commonly shared between different levels of hierarchical processing. In addition, each of the nodes interconnected on the network can be specialized in execution of its own process. Thus, it is possible to reduce the total cost for construction of the network incorporating the human-machine interface system. In addition, it is possible to provide high-performance capabilities of speech recognition and vocalized response. Further, it is possible to easily facilitate the common basis for actualization of the human-machine interfaces for all of the devices interconnected with the network. Furthermore, it is possible to achieve unification of information with regard to the processes of the speech recognition and vocalized response. Hence, it is possible to reflect adaptation results commonly in the processes. Thus, it is possible to remarkably improve the quality and grade of the human-machine interface system, which in turn raises values of products for use in the network and which results in reduction of burdens on human users of the network.

As described above, all of the devices interconnected with the network can commonly share data and programs regarding the human-machine interfaces. Hence, it is possible to unify updating and adaptation of the data and programs among the devices interconnected with the network. Therefore, it is possible to easily perform construction, maintenance and extension of the system. Incidentally, functions of the human-machine interface system actualized on the network configure distributed applications in the form of distributed objects, wherein the distributed applications are registered with the distributed application registry as application services, which are referred to by application nodes.

As described above, the aforementioned embodiments can offer the following effects.

(1) It is possible to reduce the hardware cost for each of the devices having human-machine interface functions that are interconnected with the network. This is because the devices are not required to independently provide similar functions.

(2) It, is possible to improve performance and functions of human-machine interfaces of the devices interconnected with the network. This is because the devices can share common functions therebetween on the network. As compared with the conventional devices that must have individual functions thereof, it is possible to increases the number of usable resources per each device. Hence, it is possible to actualize installation of the hardware and software of higher performance in the human-machine interface system.

(3) It is possible to unify construction, maintenance and extension of the human-machine interface system that is actualized for the devices interconnected with the network. Because of the unification, it is possible to reduce the cost in construction, maintenance and extension of the human-machine interface system. This is because the network is designed to unify and commonly reflect adaptation results, which are inevitable for improvements of the performance and quality of the human-machine interface system, in the devices having human-machine interface functions. As compared with the conventional network that reflects adaptation results in devices individually, it is possible to improve an adaptation efficiency with respect to data and programs regarding the human-machine interface functions of the devices. In the case of the maintenance and extension of the human-machine interface system on the network, the network merely requires adaptation of the data and programs to be made at the prescribed one location.

(4) It is possible to progressively increase and enhance the resources, while it is also possible to continuously use the ‘previous’ resources that are used in the past. This brings reduction of the maintenance cost and extension of the lifetime of the system. This is because the present human-machine interface system is designed based on the distributed object architecture. That is, the present system does not need ‘excessive’ initial cost because it allows addition and enhancement of the resources in response to the required processing loads. In other words, the present system can be easily reconstructed and updated in technology by utilizing advantages of hardware elements that progressively advance and are improved in cost performance recently.

By the way, the human-machine interface system of the present invention can be applied to a variety of fields. An example of the applied field is the wireless network system that is designed using application nodes, a wireless network, and service nodes. Herein, the application nodes correspond to portable information devices such as portable terminals and PDA (Personal Digital Assistants) while the service nodes correspond to workstations or large-scale computers. In addition, the application nodes can be dynamically connected with or disconnected from the network.

It may be possible to actualize the conventional human-machine interface system in the aforementioned wireless network system. However, the conventional human-machine interface system of the stand-alone type requires high-speed processors, memories, and large-capacity storage devices for the portable terminals in order to achieve high-performance human-machine interface functions. This does not accommodate the system with reasonable cost. In addition, portable devices cannot install high-performance hardware elements therein because of strict restrictions in consumption of power sources. Further, portable devices have difficulties in installing new hardware elements therein in consideration of heat emissions due to increased consumption of electric power. Furthermore, portable devices are strictly restricted in spaces for installation of hardware elements of relatively large sizes. Moreover, if portable devices independently provide additional hardware elements for actualization of high-performance human-machine interface functions, the conventional system has difficulties in commonly sharing information between the devices. Such difficulties become noticeable particularly in the case of the adaptation such as the learning. If portable devices independently provide additional hardware elements, it is necessary to perform updating and maintenance with respect to each of the devices independently, which is very troublesome for human users.

Various problems are caused by execution of human-machine interface programs on the conventional network that is not designed based on the distributed object model, which will be described below.

Because of the high dependency on the network structure and network protocol (in other words, because of the high environmental dependency), it is difficult to maintain and manage the human-machine interface system realized by private devices. Because various types of devices are possibly interconnected with the network, it is very complicated and difficult to extend the system while maintaining its functions. Therefore, it is impossible to sufficiently demonstrate prescribed effects due to integration of human-machine interface functions between the devices on the network. In other words, the conventional network has a low degree of extensibility. In addition, language processing is required to secure independence of expression media such as media representing sounds, pictures and images. The conventional technology provides independent processes for sound input, sound output, and handwritten character input respectively. Therefore, the conventional technology cannot directly offer advantages in integration of functions due to distribution of networks. In contrast, the present invention constructs the human-machine interface system based on the distributed object model. Herein, it is possible to set high-performance human-machine interface functions in the form of distributed objects, which are not necessarily installed in portable devices. Thus, it is possible to solve the aforementioned problems of the conventional technology. In addition, processes regarding the foregoing services are divided into two types of layers, namely media-dependent layers (corresponding to low-order hierarchical layers for use in the character recognition, speech recognition and speech synthesis) and media-independent layers (corresponding to high-order hierarchical layers for use in the syntax process and semantic/pragmatic process). Those layers are realized by different function units respectively. This allows the common sharing of functions between the different media as well as the common sharing of information regarding dictionaries between the devices.

Lastly, the present invention is not necessarily limited to the foregoing embodiments, hence, it is possible to provide modifications within the scope of the invention. Suppose that an application node corresponding to a terminal device performs a speech recognition process in cooperation with a service node for providing the human-machine interface service on the network, for example. In this case, the human-machine interface system actualized on the network can be easily modified to incorporate a learning process with respect to the speech recognition process. That is, the service node performs the learning process for the speech recognition process by using identification information of a human user of the terminal device. Therefore, even if the same human user uses another terminal device to access the service node, the service node can execute the speech recognition process using learning data that are made in the past. Incidentally, programs that are executed by each of the foregoing nodes can be entirely or partially distributed to the unspecified persons by using computer-readable media or by way of communication lines.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds are therefore intended to be embraced by the claims.

What is claimed is:

1. A human-machine interface system comprising:
a network; and
a plurality of nodes that are interconnected with the network, wherein human-machine interface functions are actualized in forms of distributed objects allocated to the nodes and are realized by mediating interaction between the nodes.

2. A human-machine interface system according to claim 1, wherein each of the plurality of nodes corresponds to an application node that performs input/output functions of information for a human user in execution of a specific application by way of the human-machine interface function thereof, a service node that processes the information input to or output from the application node, or a composite node that acts as an application node and/or a service node.

3. A human-machine interface system according to claim 2, wherein there are provided a low-order service node or a low-order composite node that performs data processing depending upon expression media such as sound and picture as well as a high-order service node or a high-order composite node that performs data processing independently from the expression media, so that the high-order service node or the high-order composite node is commonly shared by the low-order service node or the low-order composite node that highly depends upon different expression media respectively.

4. A human-machine interface system according to claim 2 or 3 wherein the application node or the composite node sends a start request of a prescribed service and its processing data to the service node or another composite node which in turn produces input information or output information for the application node or the composite node.

5. A human-machine interface system according to any one of claims 1 to 4, wherein each of the plurality of nodes has a hierarchical layered structure in execution of software, which is configured by arranging from a top place to a bottom place, an application node or a service node, a proxy corresponding to a high-order portion of the distributed object, a object transport structure and a remote class reference structure corresponding to a low-order portion of the distributed object, a network transport layer and a network interface circuit.

6. A computer-readable media storing programs that cause nodes corresponding to computers or processors interconnected with a network to actualize a human-machine interface system based on a distributed object model, wherein human-machine interface functions are actualized in forms of distributed objects allocated to the nodes and are realized by mediating interaction between the nodes.

7. A human-machine interface system comprising:
a network;
a plurality of nodes that are interconnected with the network, wherein human-machine interface functions are actualized in forms of distributed objects allocated to the nodes and are realized by mediating interaction between the nodes,
wherein each of the nodes corresponds to an application node that performs a prescribed application for a human user by way of a human-machine interface function thereof or a service node that provides a specific service in relation with execution of the prescribed application.

8. A human-machine interface system according to claim 7, wherein there are provided a low-order service node that performs data processing depending on expression media such as sound and picture and a high-order service node that performs data processing independently of the expression media.

9. A human-machine interface system according to claim 7, wherein each of the nodes has a hierarchical layered structure in execution of software, which is configured by arranging from a top to a bottom, an application object or a service object, a proxy, an object transport structure, a remote class reference structure, a network transport layer, and a network interface circuit.

10. A human-machine interface system according to claim 7, wherein the service corresponds to a speech recognition service or a speech synthesis service.
